(19) United States
(12) Patent Application Publication
(10) Pub. No.: US 2026/0216696 A1
(43) Pub. Date: Jul. 30, 2026

(54) SACRIFICIAL ADDITIVELY MANUFACTURED MOLD WITH CONTROLLED MOISTURE AND LIQUID ABSORPTION PROPERTIES

(71) Applicants: Stratasys, Inc., Minnetonka, MN (US); NEXA3D INC., Ventura, CA (US)

(72) Inventors: Jon JESSEN, Vekso (DK); Yoichi HAMANO, Tokyo (JP); Debora MARANI, Taastrup (DK); Tanya Henriette OLSEN, Lyngby (DK); Yuta NAKAMURA, Aichi (JP); Simone JENSEN, Taastrup (DK)

(21) Appl. No.: 19/137,848

(22) PCT Filed: Dec. 11, 2023
(86) PCT No.: PCT/EP2023/085042

§ 371 Date: Jun. 11, 2025

(30) Foreign Application Priority Data
Dec. 12, 2022 (DK) PA202270596

(51) Int. Cl. B01J 20/26; B01J 20/30; B29C 33/38; B29C 33/40; B29C 33/52; B29C 39/36; B29C 45/44; B29K 105/00; B33Y 70/00; B33Y 80/00

(52) U.S. Cl. CPC B01J 20/267; B01J 20/262; B01J 20/3007; B01J 20/3085; B29C 33/3842; B29C 33/40; B29C 33/52; B29C 39/36; B29C 45/4457; B33Y 70/00; B33Y 80/00; B29K 2105/0085; B29K 2833/26; B29K 2995/0037

(57) ABSTRACT

The present invention relates to sacrificial additively manufactured molds and mold inserts with controlled moisture and liquid absorption properties. The molds and mold inserts are suitable for use in casting and injection molding processes. The present invention also relates to a method for producing a molded article using the sacrificial additively manufactured molds and/or mold inserts. An additively manufactured mold or mold insert with controlled moisture and liquid absorption properties made of a dissolvable material for use in casting or injection molding processes, wherein the dissolvable material is an energy-cured resin comprising•a (meth)acrylamide-based monomer, •an ethylene oxide-based oligomer having energy-reactive end groups, and•a cross-linking agent, wherein the resin is further characterized by—comprising a resin solvent in an amount of 0.1-50% by weight based on total weight of the resin, preferably 0.5-40% by weight, more preferably 0.8-30% weight based on the total weight of the resin, or—comprising an ethylene oxide-based oligomer having energy-reactive end groups and an EO number in the range of 10 mol or more.

### FIELD OF THE INVENTION

The present invention relates to sacrificial additively manufactured molds and mold inserts with controlled moisture and liquid absorption properties. The molds and mold inserts are suitable for use in casting and injection molding processes. The present invention also relates to a method for producing a molded article using the sacrificial additively manufactured molds and/or mold inserts.

### BACKGROUND

Additive manufacturing—also referred to as 3D printing—has become an important tool, not only for product development but also for actual production of products. Rapid prototyping, iterative design and concept validation are three disciplines greatly facilitated by 3D printers.

A main drawback of 3D printing is the limited selection of materials and the poor mechanical properties obtained with current additive manufacturing technologies. For this reason, several manufacturers of additive manufacturing equipment and materials have begun looking for ways to combine the field of polymer additive manufacturing with the fields of casting or molding. In such combinations, the molds are produced by polymer additive manufacturing where after the cast or molded articles are produced by casting or molding using the additively manufactured molds. The key rationale behind this merging is that the technical fields of casting and molding provide a wide selection of proven materials that may be processed to superior quality levels, while the field of polymer additive manufacturing provides the option of printing molds with complex geometries that have shorter delivery times than standard aluminum or steel molds or mold inserts and may be easily modified to reflect changing design needs.

Two generic approaches are available to manufacturers who wish to combine polymer additive manufacturing with molding or casting.

A first approach is based on the polymer additive manufacturing of molds or mold inserts that are intended to be durable, and where a key objective is that the molds or mold inserts must be capable of withstanding a high number of repeated filling and mechanical demolding cycles. It is known from prior art that molds or mold inserts manufactured by polymer additive manufacturing have been adopted by manufacturers that use filling by thermoplastic injection molding for the manufacturing of a high number of identical components. Filling by thermoplastic injection molding is highly advantageous due to the ease of filling, the high manufacturing speed and the wide range of thermoplastic materials available. However, thermoplastic injection molding typically requires that a thermoplastic material (e.g., a plastic, rubber, or a powder/binder composite) is heated to between 7° and 450° C., and injected into a mold using pressures of between 0.2 and 400 MPa, which places great stresses on the mold material. Furthermore, some injected materials, such as composite materials comprising glass fibers, metal powders or similar additives, may be highly abrasive and may have high thermal capacities. In addition, molding pressures may have to be sustained after initial injection to avoid sink marks and ensure proper filling. Finally, the need to include drafts and parting lines, and to separate the mold to permit ejection of the molded articles after filling, means that the geometrical freedom from additive manufacturing is lost. Special challenges arise when molded articles are to be produced in soft and/or brittle materials and/or when molded articles with delicate properties are to be produced, because these articles may be difficult to remove from the mold or mold insert without breaking or distorting. Other challenges arise where the use of movable cores, pulls, sliders and other mechanisms are necessary for molding very complex geometries, as these moving parts will produce excessive stress, wear and tear that might lead to the rapid breakdown of the additively manufactured polymer molds or mold inserts. An additional challenge is that many thermoplastic materials will adhere to the mold, making it difficult or impossible to separate the molded article from the mold without damaging either the mold or the molded article, and which may result in limited tool life.

An alternative approach is based on the polymer additive manufacturing of molds and mold inserts (hereafter referred to either as “molds and mold inserts” or simply as “molds”) that are sacrificial, and where a key objective is that the molds can be disintegrated after filling to permit the manufacturing of complex objects with geometries that cannot be injection-molded. It is known from prior art that this principle has been adopted by manufacturers that use sacrificial additively manufactured molds for casting of thermosetting materials that may or may not be heat-treated after filling. The use of additively manufactured sacrificial molds is advantageous as it allows the manufacturing of highly complex shapes without the need for parting lines. At the same time, the combination of single-use molds and gravity pouring or lower-pressure injection means that handling of abrasive composite materials becomes less of a problem. However, the range of available thermosetting materials is considerably narrower than the range of available thermoplastic materials, and the manufacturing speed is significantly slower as the thermosetting parts will have substantially slower curing or solidification rates than the thermoplastic materials used in injection molding.

By way of example, U.S. Pat. No. 6,609,043 discloses a method for constructing a structural foam part. The method comprises three steps. Step one uses a rapid prototyping process, such as for example stereolithography, to create a polymer mold. Step two requires filling the polymer mold with a material. The document specifically discloses filling the mold with a low-viscosity slurry by pouring under the force of gravity. Alternative filling methods include the pumping of material or the chemical vapor deposition of material. The last step calls for heating the polymer mold and the material to heat set the material and remove the polymer mold due to pyrolysis of the mold material, thereby forming the structural foam portion.

As a second example, US patent application US 2015/0375419 discloses a method for producing casting molded parts where a water-soluble casting mold is produced in a first step using a layering method and in particular using a powder bed-based layering method. In a second step, the surface of the casting mold is sealed with a water-insoluble material and then a casting of the molded part is formed by filling the casting mold with a free-flowing hardenable material, in particular a hydraulically setting material. After the casting has solidified, the casting mold is dissolved with the aid of an aqueous solution and in particular a heated aqueous solution.

As a third example, International patent application WO 2019/012103 A1, discloses a method for creating a sacrificial mold suitable for thermoplastic injection molding processes at high plastic melting temperatures and injection pressures by additive manufacturing. Such materials are also very useful for investment casting and other applications requiring high resolution, high surface quality and solubility.

While important progress has been made in the use of sacrificial molds and mold elements in the manufacturing of molded parts, there are still several drawbacks that need to be addressed before additively manufactured sacrificial molds can be used more widely. A number of these disadvantages are related to the absorption properties of the resin during production and storage prior to—and during—additive manufacturing of the sacrificial mold or mold insert, as well as to the absorption properties of the sacrificial mold or mold insert during additive manufacturing, cleaning, storage and use of the mold.

During production and storage of the resin, it is difficult to avoid moisture uptake completely from the environment. As a result, the chemical and physical properties of the resin and the molds produced thereof may change. Examples of unwanted changes include changes to viscosity, translucency, printing behavior (e.g. exposure time and intensity). Moisture absorption may also cause unpredicted contraction or expansion of individual layers in the additively manufactured mold or mold element during printing, causing dimensional changes to the mold or mold insert and potentially also poor bonding between printed layers. This may result in loss of precision in the additively manufactured mold or mold insert. Moisture uptake may also compromise the mold strength and the shelf life of the mold.

During additive manufacturing of the molds or mold inserts, the resin and the printed molds or mold inserts may absorb moisture from the environment, which may result in undesired changes of printing behavior, mechanical strength and dimensional stability.

After printing, the molds or mold inserts may be cleaned in order to remove non-cured resin, which is stuck to the outside and inside of the mold. Typically, the molds or mold inserts are cleaned using a cleaning solvent, which may be absorbed by the mold or mold insert. As a result, the mechanical and dimensional behavior of the mold or mold insert may be changed.

The cleaned molds or mold inserts may be stored for some period of time before used in the casting or injection molding process. During storage, moisture may be absorbed from the environment resulting in changes in mechanical behavior and dimensional behavior.

The cleaned molds or mold inserts are filled with injection material in an injection process. Depending on the environmental conditions present during the injection, the composition of the injected material and the duration of the injection process, moisture may be absorbed from the material and/or the environment resulting in changes in mechanical behavior and dimensional behavior.

Finally, the absorption properties of the sacrificial mold material also affect the disintegration step during which the sacrificial mold or mold insert is disintegrated—frequently by dissolving, which is the method referenced in this document, though other means of disintegration may also be used—so that the molded article is released. Typically, absorption of the solvent used to dissolve the mold or mold insert will lead to swelling of the mold material, which may affect the dimensional accuracy or precision or of the molded articles or the molded articles may be deformed or otherwise damaged as a result of the excessive swelling of the sacrificial mold. Fast absorption of solvent combined with slow dissolution of the mold material may lead to an increased swelling of the mold material, which may affect the dimensional accuracy of the molded article and/or cause the molded article to crack or experience plastic strain that will affect the mechanical properties of the molded part. On the other hand, slow absorption combined with fast dissolution of the mold material will presumably lead to low levels of swelling. Slow absorption combined with slow dissolution will lead to low productivity.

It is believed that the hydrophobicity of monomers may determine the rate of solvent absorption as well as the resulting swelling. It is also believed that the cross-linking density of the polymers in the mold material after curing may affect the rate of dissolution of the mold material, and the resulting swelling or shrinkage. Among other things, the cross-linking density is believed to be influenced by the polymer molecular weight (e.g., the longer the polymer chain, the higher the cross-linking density), the reactivity of the monomers, the amount of cross-linking initiators and inhibitors, as well as the monomers' ability to transmit energy (e.g., light), which may increase or reduce the resulting cross-linking. Finally, it is also believed that the absorption depth that a solvent may reach before chemical bonds start breaking may influence the degree of swelling. The stronger the chemical bonds, the deeper absorption depth before the bonds are broken—and the greater the swelling. In most cases, the alkalinity and temperature of the solvent also influence how easily the chemical bonds are broken.

Accordingly, there is a need for sacrificial materials suitable for additive manufacturing of molds and mold inserts with moisture and liquid absorption properties that can be controlled to address these and other challenges.

### SUMMARY OF THE INVENTION

It is an object of the present invention to provide a sacrificial additively manufactured mold or mold insert with controlled moisture and liquid properties. The mold is made of a dissolvable material, which is suitable for use in casting or injection molding processes. The dissolvable mold material is an energy-cured resin, which comprises
a (meth)acrylamide-based monomer,
an ethylene oxide-based oligomer having energy-reactive end groups, and
a cross-linking agent,
   wherein the resin is further characterized by
comprising a resin solvent in an amount of 0.1-50% by weight based on the total weight of the resin,
   or
comprising an ethylene oxide-based oligomer having energy-reactive end groups and an EO number in the range of 10 mol or more.

It is a particular object of the present invention to provide a dissolvable material that is a UV curable resin, which is suitable for use in additive manufacturing of the sacrificial additively manufactured mold or mold insert made as mentioned above.

It is a further object of the present invention to provide a method for producing a molded article with a controlled moisture absorption. The method comprises the steps of:
a. additively manufacturing a sacrificial mold or mold insert made of a dissolvable material as disclosed above,
b. post-processing the mold, which post-processing may include one or more of the steps of cleaning, drying, curing and coating,
c. optionally storing the mold obtained in step b for a period of time,
d. filling the mold or mold insert obtained in step b with injection material using a casting or an injection molding process,
e. processing the injection material of step d in order to produce a molded article inside the mold by e.g., letting the injection material set or cure,
f. dissolving the mold in order to release the molded article obtained in step e, and
g. optionally rinsing the molded article.

### BRIEF DESCRIPTION OF THE FIGURES

FIG. 1 is an illustrative description of the dissolution process comprising two steps: (i) water absorption and (ii) alkaline hydrolysis of the ester function.

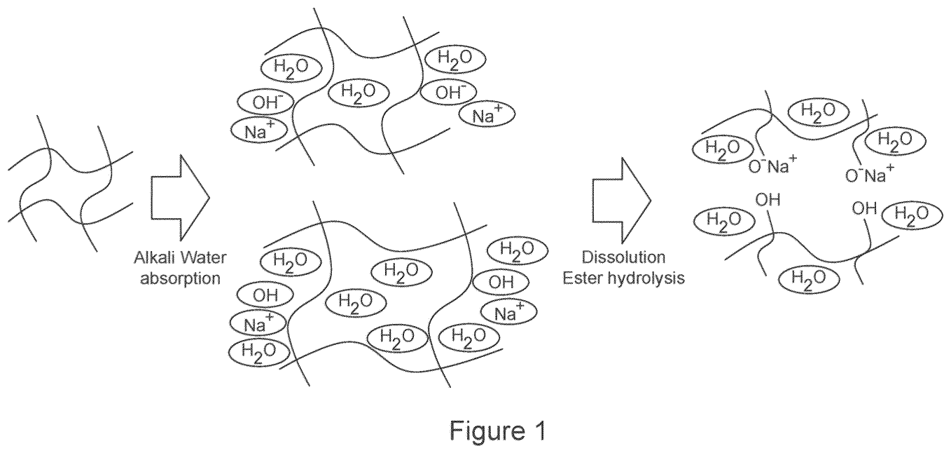

FIG. 2 shows the chemical structure of (a) acryloyl group, (b) amide group, (c) ethylene-oxide group, and (d) ester group.

FIG. 3 shows water uptake (WU) profiles at 30% RH and at a temperature of 10° C. for (a) molds or mold inserts prepared from a resin containing no solvents and from resins containing low amount of H2O (0.8 and 2% in weight), (b) molds or mold inserts prepared from a resin containing no solvents and from resins containing a low to high amount of IPA (0.8-30% in weight).

FIG. 4 shows water uptake (WU) profiles at 30% RH and at a temperature of 10° C. for molds or mold inserts prepared from a resin containing high amount of H2O (e.g., 30% in weight).

FIG. 5 is a picture of a sphere used for the demolding experiment.

### DETAILED DESCRIPTION OF THE INVENTION

It is an object of the present invention to provide additively manufactured sacrificial molds and mold inserts with controlled moisture and liquid absorption properties made of a dissolvable material for use in casting or injection molding processes. The dissolvable mold material is an energy-cured resin, which comprises
a (meth)acrylamide-based monomer,
an ethylene oxide-based oligomer having energy-reactive end groups, and
a cross-linking agent,
   wherein the resin is further characterized by
comprising a resin solvent in an amount of 0.1-50% by weight based on the total weight of the resin,
   or
comprising an ethylene oxide-based oligomer having energy-reactive end groups and an EO number in the range of 10 mol or more.

The inventors of the present invention have surprisingly found that when molds or mold inserts are additively manufactured using a resin according to the invention, molds or mold inserts with controlled moisture and liquid absorption properties are obtained. Such molds and mold inserts are less prone to be negatively affected by environmental conditions and other factors.

At a relative humidity (RH) value of 30% and a temperature in the range of 9-11° C., the level of the moisture uptake (mainly water) of the mold or mold insert at the equilibrium is lower when the resin according to the present invention comprises a resin solvent in an amount of 0.8-30% by weight based on total weight of the resin. Suitable examples of resin solvents include water and isopropanol. It is noted that an equilibrium is reached when moisture uptake is unvaried because the water molecules absorbed and desorbed in the unit of time by the molds or mold inserts are equal to each other. The equilibrium is dynamic, typically referred to as plateau. When an equilibrium is achieved, no variations in the weight of the mold or mold insert are observed until the environmental conditions (e.g., RH) are changed.

A sacrificial mold or mold insert is single-use, and sacrificed when the molded article is released from the mold or mold insert, for example by use of mechanical means, high temperature, such as pyrolysis, by chemical means, such as dissolving, by organic breakdown using microorganisms, or by a combination of the mentioned methods.

The sacrificial additively manufactured mold or mold insert may be manufactured by selectively curing layers of resin formulation on top of each other. In particular embodiments, the sacrificial resin formulation is a dissolvable resin formulation, which means that after additively manufacturing of the mold or mold insert and filling the mold with injection material to create a molded object, the cured resins, e.g., the mold or mold insert, can react with a suitable dissolving solvent whereby the printed mold or mold insert is dissolved to release the molded object.

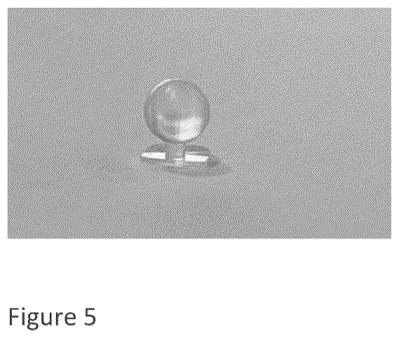

In preferred embodiments, the sacrificial additively manufactured mold is manufactured by the additive manufacturing system shown in FIG. 5 or FIG. 6 in International patent application PCT/EP2017/055841, which is incorporated herein by reference.

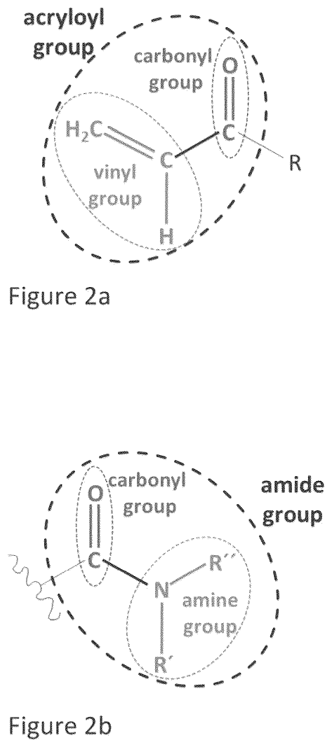

The resin comprises a (meth)acrylamide-based monomer. By the term “(meth)acrylamide-based monomer” as used herein is meant an energy-reactive monomer containing at least two functional groups, e.g., acryloyl and amide ones, enabling the monomer to undergo free radical polymerization when exposed to energy and in the presence of an initiator. By the term “acryloyl group” as used herein is meant a functional group consisting of a vinyl group (e.g., 2 carbon atoms bonded to each other by a double bond, CH2=CH—) conjugated to a carbonyl group (e.g., a carbon and an oxygen atom linked to each other by a double bond, RCH2=CH—C═O, where R is a generic organic function) as described in FIG. 2a and FIG. 2b, respectively.

The presence of (meth)acrylamide-based monomer contributes to increasing the rate of dissolution of the sacrificial mold or mold inserts.

In some embodiments, the (meth)acrylamide-based monomer is selected from the group consisting of (meth)acrylamide; N-1 substituted (meth)acrylamide compounds, such as N-isopropyl (meth)acrylamide, N-(1,1-dimethyl-3-oxobutyl)(meth)acrylamide, N-(hydroxymethyl)(meth)acrylamide, N-(butoxymethyl)(meth)acrylamide, and N-(2-hydroxyethyl)(meth)acrylamide; and N-2 substituted (meth)acrylamide compounds, such as (meth)acryloyl morpholine, (meth)acryloylpiperidine, N-(meth)acryloylpyrrolidine N-(meth)acryloyl-4-piperidone, N,N-dimethyl(meth)acrylamide, N,N-diisopropyl (meth)acrylamide, N,N-methylene-bis(meth)acrylamide, and N,N-dimethylaminopropyl (meth) acrylamide.

In some embodiments, only one type of (meth)acrylamide-based monomer is present in the resin, whereas in other embodiments two or more types of (meth)acrylamide-based monomers are present in the resin.

Preferred examples of (meth)acrylamide-based monomer include acryloyl morpholine, N,N-dimethylacrylamide and N-(2-hydroxyethyl)acrylamide due to their solubility properties in alkaline solvents.

The amount of (meth)acrylamide-based monomer in the resin is preferably in the range of 20 to 95 parts by weight relative to a total amount of 100 parts by combined weight of the (meth)acrylamide-based monomer and the ethylene oxide-based oligomer having energy-reactive end groups. The lower limit of the range is more preferred 30 parts by weight or more, even more preferred 50 parts by weight or more. The upper limit is more preferred 95 parts by weight or less, and even more preferred 80 parts by weight or less.

In embodiments where the amount of the (meth)acrylamide-based monomer is increased above 30 parts by weight, more specifically between 40 and 95 parts by weight in the resin, the rate of dissolution of the sacrificial mold or mold inserts is increased.

Considering the dissolution process of a mold or mold insert as a process consisting of two steps, namely water absorption and dissolution via alkaline hydrolysis of the ether/ester groups, the entire dissolution process can be controlled by designing the reciprocal ratio between the (meth)acrylamide-based monomer and the ethylene oxide-based oligomer having energy-reactive end groups and their specific properties. Specifically, such design has to address the water affinity of the (meth)acrylamide-based monomer and the EO number/density of the ethylene oxide-based oligomer having energy-reactive end groups. Accordingly, the higher the amount of the (meth)acrylamide-based monomer in the resin, the greater the ability to absorb water. In addition to that, the more hydrophilic character of the (meth)acrylamide-based monomer, the greater the water absorption.

The resin comprises an ethylene oxide-based oligomer having energy-reactive end groups. By the term “ethylene oxide-based oligomer having energy-reactive end groups” as used herein is meant a molecule containing a few repeating units of ethylene oxide functions and energy-reactive end functions, e.g., an acryloyl group (as defined above). The ethylene oxide-based oligomer confers flexibility to the energy-cured mold or mold insert. By the term “ethylene oxide functions” as used herein is meant functional groups consisting of ether linkages in their main chains, as described in FIG. 2c. The same group, when it is considered as a group linked to the acryloyl, can be referred to as an ester group (FIG. 2d).

Considering the dissolution process of a mold or mold insert as a process consisting of two steps, namely water-absorption and dissolution via alkaline hydrolysis of the ester groups, the entire dissolution process can be controlled by designing the reciprocal ratio between the (meth)acrylamide-based monomer and the ethylene oxide-based oligomer having energy-reactive end groups and their specific properties. Specifically, such design has to address the EO number/density of the ethylene oxide-based oligomer having energy-reactive end groups that control the dissolution of the mold or mold insert. Accordingly, the higher the amount of the ethylene oxide-based oligomer having energy-reactive end groups in the resin the greater the ability to dissolve. In addition to that, the higher the EO number of the ethylene oxide-based oligomer having energy-reactive end groups, the faster is the dissolution.

The presence of ethylene oxide-based oligomer having energy-reactive end groups contributes to improving the dissolution of the sacrificial mold or mold insert and to the ability of these molds and mold inserts to withstand elevated injection pressures and/or temperatures, which is particularly important in cases where the mold is filled with injection material at pressures above 0 MPa and/or temperatures above 40° C., especially from 70 to 450° C., and/or pressures of between 0.2 and 400 MPa.

In some embodiments, the ethylene oxide-based oligomer having energy-reactive end groups is selected from the group consisting of (poly)ethylene glycol di(meth)acrylate, EO-modified bisphenol-A di(meth)acrylate, tri(2-hydroxyethyl) isocyanurate tri(meth)acrylate and EO-modified trimethylol propane tri(meth)acrylate. Oligomers modified by having a functional group, such as a hydroxyl group, a carboxyl group, an amino group, a mercapto group, and/or a silanol group bonded to the oligomer are also included.

In some embodiments only one type of ethylene oxide-based oligomer having energy-reactive end groups is present in the resin, whereas in other embodiments two or more types of ethylene oxide-based oligomers having energy-reactive end groups are present in the resin.

Preferred examples of ethylene oxide-based oligomer having energy-reactive end groups include (poly)ethyleneglycol di(meth)acrylate and EO-modified trimethylolpropane tri(meth)acrylate due to their solubility properties in alkaline solvents.

Typically, the EO number of the ethylene oxide-based oligomer having energy-reactive end groups is 10 mol or more, more preferred 12 mol or more and even more preferred 14 mol or more due to the increased dissolution rate of the molds or mold inserts in alkaline solvents.

In some embodiments, the absorption of moisture and/or liquid is controlled by incorporating an ethylene oxide-based oligomer having energy-reactive end groups and an EO number in the range of 10 mol or more, such as in the range of 10-300 mol, more preferred in the range of 14-200 mol.

The amount of the ethylene oxide-based oligomer having energy-reactive end groups is preferably 5 to 80 parts by weight relative to a total amount of 100 parts by combined weight of the (meth)acrylamide-based monomer and the ethylene oxide-based oligomer having energy-reactive end groups. The lower limit of the range is preferably 10 parts by weight or more, more preferred 20 parts by weight or more, and the upper limit is preferably 70 parts by weight or less, and more preferred 50 parts by weight or less.

In embodiments where the amount of the ethylene oxide-based oligomer having energy-reactive end groups in the resin is high, the molds or mold insert's ability to withstand elevated injection pressures and/or temperatures is increased. This is particularly important in cases where the mold is filled with injection material at pressures above 0 MPa and/or temperatures above 40° C., especially from 70 to 450° C., and/or pressures of between 0.2 and 400 MPa. In embodiments where the amount of the ethylene oxide-based oligomer having energy-reactive end groups in the resin is low, the dissolution rate of the sacrificial molds or molds inserts is increased.

The resin also comprises a cross-linking agent. In some embodiments, the energy cross-linking agent is a UV cross-linking agent, whereas in other embodiments the cross-linking agent is a thermal cross-linking agent or a chemical cross-linking agent. By the term “cross-linking agent” as used herein is meant a compound containing reactive end groups that are capable of initiating a cross-linking reaction with the (meth)acrylamide-based monomer and/or the ethylene oxide-based oligomer having energy-reactive end groups to promote the formation of a cross-linked network. Likewise, by the term “UV cross-linking agent” as used herein is meant a compound containing UV-reactive end groups.

A cross-linking agent is used to promote the formation of a cross-linked network by inducing covalent bonds between the constituents in a resin, for example monomers and oligomers and the cross-linking agent itself, in a way that the cross-linking agent is chemically incorporated, via covalent bonds, into the cross-linked network. An energy cross-linking agent promotes the formation of cross-linked network when exposed to some kind of energy, for example UV light.

In an embodiment, the cross-linking agent is a UV cross-linking agent and is selected from the group consisting of 2-Benzyl-2-dimethylamino-1-(4-morpholinophenyl)-butanone-1, (Dimethylhydroxyaceto-phenone, 1-Hydroxy-cyclohexylphenyl-ketone, “Dimethylhydroxyacetophenone, 2-Hydroxy-2-methyl-1-phenyl-1-propanone” Benzil dimethyl ketal 2,2-methoxy-1,2-diphenyl ethanone, Diphenylmethanone, multifunctional thioxanthone, 2,2-Diethoxyacetophenone, Methylbenzoylformate, 4-Methylbenzophenone, 2,4-Diethylthioxanthone, o-Methylbenzoylbenzoate, 1-(9,9-Dibutyl-9H-fluoren2-yl)-2-methyl-2-morpholin-4-yl-propan-1-one, 4-(4-methylphenylthio) benzophenone, 2-methyl-1-(4-methylthio) phenyl-2-morpholinopropan-1-one, Methyl benzoylformate, Phenylbis (2,4,6-trimethylbenzoyl) phosphine oxide, 4,4′-Bis (diethylamino) benzophenone, Isopropylthioxanthone, Diphenyl(2,4,6-trimethylbenzoyl) phosphine oxide, 4-Phenylbenz-ophenone, 1,7,7-Trimethylbicyclo, Benzophenone, Acetophenone, Anisoin, Anthraquinone, Anthraquinone-2-sulfonic acid, sodium salt monohydrate,

Benzil, (Benzene) tricarbonylchromium, Benzoin ethyl ether, Benzoin, Benzoin isobutyl ether, Benzoin methyl ether, Benzophenone, 3,3′,4,4′-Benzophenonetetracarboxylic dianhydride, 4-Benzoylbiphenyl, Camphorquinone, 2-Chlorothioxanthen-9-one, (Cumene)cyclopentadienyliron(II) hexafluorophosphate, Dibenzosuberenone, 2,2-Diethoxyacetophenone, 4,4′-Dihydroxybenzophenone, 2,2-Dimethoxy-2-phenylacetophenone, 4-(Dimethylamino)benzophenone, 4,4′-Dimethylbenzil, 2,5-Dimethylbenzophenone, 3,4-Dimethylbenzophenone, 4′-Ethoxyacetophenone, Ethylanthraquinone, Ferrocene, 3′-Hydroxyacetophenone, 4′-Hydroxyacetophenone, 3-Hydroxybenzophenone, 4-Hydroxybenzophenone, 1-Hydroxycyclohexyl phenyl ketone, 2-Hydroxy-2-methylpropiophenone, 2-Methylbenzophenone, 3-Methylbenzophenone, Methybenzoylformate, Phenanthrenequinone, 4′-Phenoxyacetophenone, Thioxanthen-9-one.

In some embodiments, the resin also comprises a resin solvent that is incorporated to fully or partially saturate the resin with the goal to control the absorption of moisture and/or liquid in the resin as such as well as in the additively manufactured mold or mold insert.

The resin solvent may be any kind of solvent, which is compatible with the other components in the resin and which does not interfere with the additive manufacturing process. Some embodiments incorporate resin solvents that may promote specific desirable properties in the resin, such as to increase the tensile strength or the glass transition temperature of an additively manufactured sacrificial mold or mold insert. Other embodiments incorporate resin solvents that may inhibit specific undesirable properties in the resin, such as excessive dissolving time. Some embodiments incorporate only one solvent, whereas other embodiments comprise two or more solvents. In particular embodiments, the resin solvent is not allowed to interfere with the energy curing process during the additive manufacturing process

The resin solvent is preferably a polar solvent. Polar resin solvents are advantageous because they can exert electrical forces on a solute due to the electronegativity differences among their atoms. The electronegativity difference is responsible for the dipole moment and charge separation, that makes a polar resin solvent chemically compatible with the relevant resin ingredients of the current invention (e.g., monomer, oligomer and so on). The polarity of a solvent is measured by the value of its dielectric constant (ε) at a given temperature. The higher the dielectric constant, the greater the electric forces exerted, and therefore the interactions between the solvent molecules and specific polar functions/groups of a solute. The amount of resin solvent may be in the range of 0.1-50% by weight based on total weight of the resin, preferably 0.5-40% by weight, more preferably 0.8-30% by weight based on total weight of the resin.

In some embodiments, the resin solvent has a dielectric constant close to the dielectric constant of water. In such embodiments, it is observed that the absorption of water or moisture from the environment is slowed down over a period of 24 h. This reduced absorption will improve the dimensional stability and minimize the dimensional changes resulting from changes in environmental humidity and temperature.

In some embodiments, it is preferred to reach the absorption plateau to allow as little absorption as possible compared to the pristine (non-solvent modified) resin formulation for the molds or mold inserts. The achievement of the absorption plateau is especially useful when molds or mold inserts are to be stored for a longer period of time, or if the production time of the mold exceeds 24 hours. Some embodiments are also designed for long-term storage in humid conditions

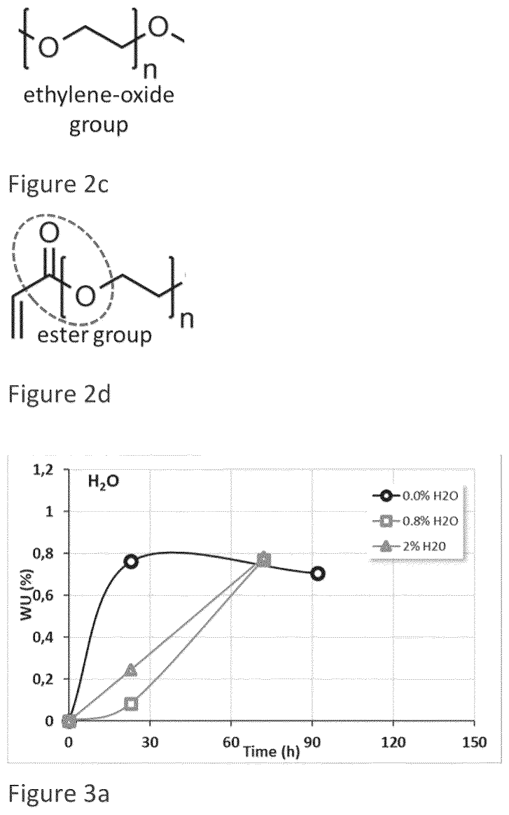

In the case of high polar resin solvents e.g., water, it is observed that within 72 h of exposure to the defined stored conditions (e.g., 30% RH and 10° C.), a plateau has not been yet reached, and we have reached the same absorption level as the pristine molds, and therefore there is not a beneficial effect of adding a high polar resin solvent in this specific scenario, as it can be seen in FIG. 3a. On the other hand, when using a resin solvent with a polarity lower than water (lower value of the dielectric constant), in this specific scenario IPA, under the same conditions, it is observed that the plateau is reached after 30 hours as it can be seen in FIG. 3b.

Suitable examples of resin solvents include alkaline solvents and acidic water, demineralized water, purified water, methanol, ethanol, isopropyl alcohol, n-butanol, isobutanol, octanol, n-propyl alcohol, and acetylacetone alcohol; glycol-based solvents, such as ethylene glycol, ethylene glycol monomethyl ether, ethylene glycol monomethyl ether, ethylene glycol mono n-propyl ether, ethylene glycol mono n-butyl ether, diethylene glycol monomethyl ether, diethylene glycol monoethyl ether, propylene glycol monomethyl ether, propylene glycol monoethyl ether, propylene glycol monobutyl ether, tripropylene glycol monomethyl ether, ethylene glycol monomethyl ether acetate, propylene glycol monomethyl ether acetate, propylene glycol monomethyl ether acetate, methyl cellosolve, butyl cellosolve, and diethylene glycol ethyl ether; ketone-based solvents, such as acetone, methyl ethyl ketone, methyl isobutyl ketone, diisobutyl ketone, cyclohexanone, diacetone alcohol, and isophorone; hydrocarbon-based solvents, such as toluene, xylene, tetramethylbenzene, petroleum ether, petroleum naphtha, hydrogenated petroleum naphtha, solvent naphtha, cyclohexane, methylcyclohexane, octane, and decane; and ester-based solvents, such as ethyl acetate, propyl acetate, butyl acetate, isobutyl acetate, and amyl acetate. These may be used singly or in combination of two or more kinds thereof.

Other ways to control the absorption of moisture during storage include the addition of desiccants, e.g., bags of silica gel, to the storage container containing the additively manufactured molds or mold inserts.

The resin may also comprise one or more other additives, such as a filler, an UV absorber, a polymerization inhibitor, dispersant, or any mixture thereof.

In some embodiments, the resin further comprises one or more filler(s). The filler is a solid additive, which is not dissolvable in the liquid resin. The filler may be a hydrophilic filler, a hydrophobic filler and/or an inert filler. Suitable examples of fillers include carbon-based materials, such as graphene, carbon nanotubes, carbon fibers and graphite, metals in the form of powder, such as steel, iron, copper, silver, gold, tin, gallium, magnesium, nice, zinc, titanium, tungsten, aluminum, ceramics in the form of powder, such as alumina, titania, zirconia, ceria, tungsten oxide, magnesium oxide, hematite, tin oxide, zinc oxide, yttria, minerals in the form of powder, such as clay, marble, barite, sand, agate, dolomite, vermiculite, gypsum, polymers, such as PEEK, PBI, POM, PEI, PMMA, PC, PS, PTFE, PV PSU, PA, PPO, TPE, PP, ABS, and organic fibers, such as wood, cotton, hemp, flax, silk.

When a component that is not soluble in the fluid resin is added to the resin, the resulting system is a two-phase composite system, where the insoluble component is suspended in the fluid resin. Accordingly, two phases may be defined: a fluid resin phase and an insoluble phase. The simultaneous presence of the two interrelated phases introduces then the concept of tortuosity that can either promote or suppress the diffusion/absorption of water depending on the reciprocal ratio between the two phases.

In a preferred embodiment, the filler is an inert filler. An inert filler does not affect the ability of the resin to dissolve. An inert filler does not react with the resin or the dissolving solvent. The inert filler may increase the length of the pathway that the dissolving solvent will have to travel in order to be absorbed and dissolve the mold. An increased length of pathway will increase the amount of time it will take to dissolve a mold. As an effect of slowing down the absorption, the penetration depth, i.e. the portion of the mold that has absorbed the dissolving solvent can be less, which is seen as a thinner layer of the mold that has absorbed the dissolving solvent in a given time. The reduced rate of absorption may not affect the swelling of the cured resin constituting the mold, but it may decrease the amount of solvent affected mold material, and thus the measurable amount of swelled mold material over a given time. Accordingly, the addition of an inert filler may result in a reduced total swelling of the mold. This effect can be increased by decreasing the particle size of the filler and/or by increasing the amount of filler. The higher the amount of filler in the mold material, the smaller the amount of resin that has to be dissolved, and thereby the dissolving time of the resin may be decreased.

In another preferred embodiment, the filler is a hydrophilic filler. A hydrophilic filler is a filler that has an affinity to water. In some embodiments, the hydrophilicity of the filler is higher than that of the resin. The hydrophilic filler may increase the transfer of solvent into the mold, and in some cases the filler will furthermore be dissolved by the dissolving solvent. In both cases, the addition of a hydrophilic filler may increase the surface of the cured resin and thereby increase the rate of the absorption. This may cause more swelling as a larger amount of resin is absorbing over the same period of time, unless the increased swelling is balanced by an opposing increase in the dissolution. Furthermore, if the filler also swells during absorption or dissolution this can contribute to the total amount of swelling of the mold. On the other hand, if the filler has a lower affinity to water than the resin, the total absorption rate can be lowered and the swelling can be lower than that of the resin alone. In both cases it is possible to increase the amount of filler in the resin by volume, and decrease the particle size to further promote a desired effect.

In yet another preferred embodiment, the filler is a hydrophobic filler. A hydrophobic filler may have the same effect in the resin and mold as the inert filler due to the nature of being hydrophobic (repelling water).

In order to suspend a filler (inert, hydrophobic, and hydrophilic) it can be necessary to coat the filler particles with an appropriate surfactant containing chemical functional groups that interact with the chemical functional groups of the resin components, thereby enabling the suspensions of particles that otherwise may settle or sediment upon the action of the gravity force or as a result of attractive forces.

In some embodiments, both inert and/or hydrophobic fillers combined with hydrophilic fillers can be used to balance the rate of absorption and dissolution and to thereby lower the amount of swelling of the mold.

A specific embodiment comprises a brittle yet soluble resin formulation that is loaded with a hydrophilic filler with a swelling rate that is much larger than the resin, and is also loaded with an inert filler. In this particular embodiment, a mechanical breakdown of the mold made of such resin is induced as the hydrophilic filler expands faster than the mold can absorb the solvent, which results in a full or partial breakdown of parts of the mold, only leaving a smaller portion to be dissolved.

In some embodiments the resin comprises an inert filler that can reduce the parts by weight of water affine components (e.g., resin ingredients), making the mold or mold insert less susceptible to undergo excessive swelling, thereby enabling a measure of control over the swelling. Other embodiments comprise fillers that are either fully or partially recyclable, and may contribute to the reduction of resin consumption.

In some embodiments, the resin further comprises an ultraviolet absorber, which contributes to improvement in shaping accuracy of the sacrificial mold according to the present composition.

Suitable examples of an ultraviolet absorber include triazine-based compounds, such as 2-[4-{(2-hydroxy-3-dodecyloxypropyl)oxy}-2-hydroxyphenyl]-4,6-bis(2,4-dimethylphenyl)-1,3,5-triazine, 2-[4-{(2-hydroxy-3-tridecyloxypropyl)oxy}-2-hydroxyphenyl]-4,6-bis(2,4-dimethylphenyl)-1,3,5-triazine and 2-{4-(octyl-2-methylethanoate)oxy-2-hydroxyphenyl-4,6-{bis(2,4-dimethylphenyl)}-1,3,5-triazine; benzophenone-based compounds, such as 2,4-dihydroxybenzophenone and 2-hydroxy-4-methoxybenzophenone; benzotriazole-based compounds, such as 2-(2H-benzotriazol-2-yl)-4,6-bis(1-methyl-1-phenylethyl) phenol and 2-(2H-benzotriazol-2-yl)-6-(1-methyl-1-phenylethyl)-4-(1,1,3,3-tetramethylbutyl)phenol; phenyl benzoate-based compounds, such as phenyl salicylate, p-tert-butylphenyl salicylate and p-(1,1,3,3-tetramethylbutyl)phenyl salicylate; phenyl salicylates and phenyl salicylate-based compounds, such as 3-hydroxyphenyl benzoate and phenylene-1,3-dibenzoate; benzoxazole compounds, such as 2,5-thiophenediylbis(5-tert-butyl-1,3-benzoxazole); and oxalate anilide-based compounds, such as 2-ethoxy-2′-ethyloxalanilide and 2-ethoxy-2′-dodecyloxalanilide. In some embodiments, the resin only comprises one ultraviolet absorber, whereas in other embodiments the resin comprises a combination of two or more ultraviolet absorbers. The most preferred UV absorber is 2,5-thiophenediylbis(5-tert-butyl-1,3-benzoxazole) because it contributes to enhanced shaping accuracy of the sacrificial mold.

Typically, the amount of the absorber is in the range of 0.001 to 3 parts by weight relative to a total amount of 100 parts by combined weight of the (meth)acrylamide-based monomer and the ethylene oxide-based oligomer having energy-reactive end groups. The lower limit of the range is preferably 0.003 parts by weight or more, more preferred 0.01 parts by weight or more, and the upper limit is preferably 1 part by weight or less, more preferred 0.3 parts by weight or less.

In embodiments where the amount of the absorber in the resin is high, the shaping accuracy of the obtained sacrificial mold is enhanced. In embodiments where the amount of the UV absorber in the resin is low, the curability of the resin is enhanced.

In some embodiments, the resin also comprises a polymerization inhibitor. By the term “polymerization inhibitor” as used herein is meant a compound that prevents undesired polymerization caused by chain reactions during curing, often caused by exposure to light or heat and to ease the production process allowing some light to be present during production. The polymerization inhibitor contributes to storage stability of the resin allowing for a longer shelf life of the resin and the sacrificial molds and mold inserts. It also allows storage at higher temperatures, often between 20° C. and 50° C. Moreover, the presence of polymerization inhibitor in the resin improves dimensional accuracy of the additively manufactured sacrificial mold and mold inserts, the polymerization inhibitor also decreases the degree of undesired reaction of the resin outside the energy exposure zone during the printing of a layer.

Suitable examples of polymerization inhibitors include glycerol propoxylated, phenothiazine, tris(4-nitrophenyl) methyl radical, bis(4-fluorophenyl) amine, 1,1-diphenyl-2-picrylhydrazyl radical, 4-methyl-4-phenoxy-N-phenylpentan-2-imine oxide, benzoquinone, hydroquinone, 4-methoxyphenol, 3-butylbenzene-1,2-diol, nitrosobenzene, picric acid, dithiobenzoyl disulfide, cuperone, and copper(II) chloride may be used. In some embodiment, only one polymerization inhibitor is present in the resin, whereas in other embodiments two or more polymerization inhibitors are present in the resin. The preferred polymerization inhibitor is 4-methoxyphenol because it enhances the storage stability of the resin according to the present invention.

The amount of polymerization inhibitor in the resin is preferably 0.001 to 3 parts by weight relative to a total amount of 100 parts by combined weight of the (meth)acrylamide-based monomer and the ethylene oxide-based oligomer having energy-reactive end groups. The lower limit of the range is preferably 0.003 parts by weight or more, more preferred 0.01 parts by weight or more, and the upper limit is preferably 1 part by weight or less, and more preferred 0.3 parts by weight or less.

In embodiments where the amount of polymerization inhibitor is high, the storage stability of the resin is enhanced. In embodiments where the amount of polymerization inhibitor is low, the curability of the resin is enhanced.

The resin may also contain other polymerizable components (hereinafter referred to as “other polymerizable components”) other than the (meth)acrylamide-based monomer and the ethylene oxide-based oligomer having energy-reactive end groups. Examples of other polymerizable components include monofunctional (meth)acrylate, difunctional (meth)acrylate, tri or more functional (meth)acrylate, vinyl compound, and allyl compound.

As used herein by the term “alkylene oxide modified” is meant an alkylene oxide having 2 to 10 carbon atoms, such as a compound other than the ethylene oxide-based oligomer having energy-reactive end groups, for example propylene oxide, butylene oxide, isobutylene oxide, 1-butene oxide, 2-butene oxide, trimethyl ethylene oxide, tetramethylene oxide, tetramethyl ethylene oxide, butadiene monoxide, octylene oxide, styrene oxide are introduced into the molecular structure.

Suitable examples of other polymerizable components include monofunctional (meth)acrylate, for example, methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, 2-hydroxylethyl (meth)acrylate, 2-hydroxypropyl (meth)acrylate, 4-hydroxybutyl (meth)acrylate, benzyl (meth)acrylate, cresol (meth)acrylate, dicyclopentenyl (meth)acrylate, dicyclopentenyloxyethyl (meth)acrylate, phenyl (meth)acrylate, 7-amino-3,7-dimethyloctyl (meth)acrylate, 2-ethylhexyl (meth)acrylate, 2-(diethylamino)ethyl (meth)acrylate, lauryl (meth)acrylate, 2-methoxyethyl methacrylate, polyepoxy mono (meth)acrylate, polyester mono (meth)acrylate, (meth)acrylate of phenol alkylene oxide modified, (meth)acrylate of o-phenylphenol alkylene oxide modified, (meth)acrylate of 4-(2-phenylpropan-2-yl)phenol alkylene oxide modified, (meth)acrylate of nonylphenol alkylene oxide modified, (meth)acrylate of 2-ethylhexyl alcohol alkylene oxide modified, hydroxypentyl (meth)acrylate, hydroxyhexyl (meth)acrylate, mono (meth)acrylate of diethylene glycol, mono (meth)acrylate of triethylene glycol, mono (meth)acrylate of polyethylene glycol, mono (meth)acrylate of dipropylene glycol, mono (meth)acrylate of polypropylene glycol, 2-hydroxy-3-phenoxypropyl (meth)acrylate, tetrahydrofurfuryl (meth)acrylate, caprolactone-modified tetrahydrofurfuryl (meth)acrylate, (2-ethyl-2-methyl-1,3-dioxolan-4-yl) methyl (meth)acrylate, (1,4-dioxaspiro[4,5]decan-2-yl) methyl (meth)acrylate, glycidyl (meth)acrylate, 3,4-epoxycyclohexylmethyl (meth)acrylate, (3-ethyloxetan-3-yl) methyl (meth)acrylate, allyl (meth)acryloyloxyethyl hexahydrophthalimide, N-(meth)acryloyloxyethyl tetrahydrophthalimide, 2-(meth)acryloyloxyethyl hexahydrophthalic acid, 2-(meth)acryloyloxyethyl succinic acid, ω-carboxy-polycaprolactone mono (meth)acrylate, 2-(meth)acryloyloxyethyl acidphosphate, 3-(meth)acryloyloxypropyl dimethoxymethylsilane, 3-(meth)acryloyloxypropyltriethoxysilane, and 2-(meth)acryloyloxyethyl acid phosphate.

Suitable examples of difunctional (meth)acrylates include, propylene glycol di(meth)acrylate, 1,4-butanediol di(meth)acrylate, neopentyl glycol di(meth)acrylate, 1,6-hexanediol di(meth)acrylate, 3-methyl-1,5-pentanediol di(meth)acrylate, 2-butyl-2-ethyl-propanediol di(meth)acrylate, tricyclodecanedimethylol di(meth)acrylate, 1,9-nonanediol di(meth)acrylate, 1,4-cyclohexanediol di(meth)acrylate, tricyclodecane dimethanol di(meth)acrylate, diethylene glycol di(meth)acrylate, dipropylene glycol di(meth)acrylate, triethylene glycol di(meth)acrylate, tripropylene glycol di(meth)acrylate, bisphenol-A di(meth)acrylate, hydrogenated bisphenol-A di(meth)acrylate, polycarbonate di(meth)acrylate, di(meth)acrylate anhydrides, polycaprolactone adducts of these monomers, polycarbonate adducts, polyepoxidi(meth)acrylate, polyester di(meth)acrylate, di(meth)acrylate of alkylene oxide modified, di(meth)acrylate of isocyanurate alkylene oxide modified, and urethane (meth)acrylate.

Suitable examples of tri or more functional (meth)acrylates include trimethylolpropane-based compounds, such as pentaerythritol tri(meth)acrylate, pentaerythritol tetra(meth)acrylate, dipentaerythritol hexa (meth)acrylate, trimethylolpropane tri(meth)acrylate, and neopentylglycol-modified trimethylolpropane di(meth)acrylate, ditrimethylolpropane tetra(meth)acrylate; isocyanurate-based compounds, such as bis(2-acryloyloxyethyl)-2-hydroxyethylisocyanurate; pentaerythritol tri(meth)acrylate adducts to succinic anhydride; polyfunctional (meth)acrylate, such as dipentaerythritol penta (meth)acrylate adduct to succinic anhydride; polyester (meth)acrylate having a carbonate bond, such as a reactant of an oligoester and a pentaerythritol tri(meth)acrylate using a side chain or a polyester oligomer having an acryloyl group at a side chain and a terminal; polyurethane tri(meth)acrylate; and polyfunctional dendrimer (meth)acrylate.

Suitable examples of the vinyl compounds include styrene, methyl styrene, dimethyl styrene, trimethyl styrene, isopropyl styrene, chloromethyl styrene, methoxy styrene, acetoxy styrene, chloro styrene, dichloro styrene, bromo styrene, vinylbenzoic acid methyl ester, 3-methylstyrene, 4-ethylstyrene, 3-propylstyrene, 4-butylstyrene, 3-hexylstyrene, 3-octylstyrene, 4-octylstyrene, 3-(2-ethylhexyl) styrene, 4-(2-ethylhexyl) styrene, isopropenylstyrene, butenylstyrene, 4-t-butoxystyrene, vinyl acetate, vinyl benzoate, vinyl toluene, acrylonitrile, vinylpyridine, vinyl chloride, N-vinylpyrrolidone, N-vinylcaprolactam, and N-vinylformamide.

Suitable examples of the allyl compounds include allyl alcohol, such as allyl glycidyl ether, diallyl phthalate and triallyl trimellitate.

In some embodiments, the resin only comprises one other polymerizable component, whereas in other embodiments the resin comprises two or more other polymerizable components.

The amount of the other polymerizable component in the resin is 0 to 50 parts by weight relative to a total amount of 100 parts by combined weight of the (meth)acrylamide-based monomer and the ethylene oxide-based oligomer having energy-reactive end groups. The upper limit is preferably 30 parts by weight or less, more preferred 10 parts by weight or less. In embodiments where the amount of other polymerizable components is low, the solubility of the mold in alkaline solvent is enhanced.

The resin may also comprise photo-initiators. By the term “photo-initiator” as used herein is meant a compound that upon light absorption undergoes photochemical cleavage to produce species (e.g., radicals) that react with the other ingredients of the resin containing reactive functions, e.g., vinyl groups. The choice of photoinitiator is not particularly limited as long as it generates radicals by the action of light. Suitable examples include acetophenone-based compounds, such as diethoxyacetophenone, 2-hydroxy-2-methyl-1-phenylpropane-1-one, benzyldimethylketal, 4-(2-hydroxyethoxy)phenyl-(2-hydroxy-2-propyl)ketone, 1-hydroxycyclohexylphenyl ketone, 1-[4-(2-hydroxyethoxy)-phenyl]-2-hydroxy-2-methyl-1-propane-1-one, 2-methyl-2-morpholino (4-thiomethylphenyl) propan-1-one, 2-benzyl-2-dimethylamino-1-(4-morpholinophenyl)butanone, and 2-hydroxy-2-methyl-1-[4-(1-methylvinyl)phenyl]propanone oligomers; benzoin-based compounds, such as benzoin, benzoin methyl ether, benzoin ethyl ether, benzoin isopropyl ether, and benzoin isobutyl ether; benzophenone-based compounds, such as benzophenone, methyl 2-benzoylbenzoate, 4-phenyl benzophenone, 4-benzoyl-4′-methyl-diphenylsulfide, 3,3′,4,4′-tetra (t-butylperoxycarbonyl)benzophenone, 2,4,6-trimethylbenzophenone, 4-benzoyl-N,N-dimethyl-N-[2-(1-oxo-2-propenyloxy)ethyl]benzenemethanaminium bromide, and (4-benzoylbenzyl) trimethylammonium chloride; thioxanthone-based compounds, such as 2-isopropylthioxanthone, 4-isopropylthioxanthone, 2,4-diethylthioxanthone, 2,4-dichlorothioxanthone, 1-chloro-4-propoxythioxanthone, and 2-(3-dimethylamino-2-hydroxy)-3,4-dimethyl-9H-thioxanthone-9-one meso-chloride; acylphosphine oxide-based compounds, such as 2,4,6-trimethylbenzoyl-diphenylphosphine oxide, 2,4,6-trimethylbenzoylphenylphosphonic acid ethyl ester, bis(2,6-dimethoxybenzoyl)-2,4,4-trimethyl-pentylphosphine oxide, bis(2,4,6-trimethylbenzoyl)-phenyl phosphine oxide. In some embodiments, the resin only comprises one photoinitiator, whereas in other embodiments the resin comprises two or more photoinitiators.

In some embodiments the resin comprises one or more of triethanolamine, triisopropanolamine, 4,4′-dimethylaminobenzophenone (michler's ketone), 4,4′-diethylaminobenzophenone, 2-dimethylaminoethylbenzoic acid, ethyl 4-dimethylaminobenzoate, isoamyl 4-dimethylaminobenzoate, 2-ethylhexyl 4-dimethylaminobenzoate, 2,4-diethylthioxane, and 2,4-diisopropylthioxane for improving curability of the resin.

In other embodiments, the resin contains a thermal initiator. The thermal initiator is not particularly limited, and a known thermal initiator can be appropriately used. For example, an azo compound such as 2,2′-azobisisobutyronitrile, 2,2′-azobis(2-methylbutyronitrile), 2,2′-azobis(2,4-dimethylvaleronitrile), dimethyl 2,2′-azobisisobutyrate, 2,2′-azobis(2-methylpropion amidine) dihydrochloride; an organic peroxide such as cumylperoxy neodecanoate, 1,1,3,3-tetramethylbutylperoxy neodecanoate, t-hexylperoxy neodecanoate, t-butylperoxy neodecanoate, t-hexylperoxy pivalate, t-butylperoxy pivalate, 1,1,3,3-tetramethylbutylperoxy 2-ethylhexanoate, 2,5-dimethyl-2,5-bis(2-ethylhexanoylperoxy) hexane, t-hexylperoxy 2-ethylhesanoate, t-butyperoxy 2-ethylhexanoate, t-butylperoxy isobutylate, t-hexylperoxy isopropyl monocarbonate, t-butylperoxy-3,5,5-trimethylhexanoate, t-butylperoxy laurate, t-butylperoxy isopropyl monocarbonate, t-butylperoxy 2-ethylhexyl monocarbonate, t-hexylperoxy benzoate, 2,5-dimethyl-2,5-bis(2-benzoylperoxy)hexane, t-butylperoxy benzoate, lauroylperoxide, stearoylperoxide, benzoylperoxide, bis(4-t-butylcyclohexyl)peroxydicarbonate, diisopropyl benzene hydroperoxide, cumene hydroperoxide, t-hexyl hydroperoxide, and t-butyl hydroperoxide; an inorganic peroxide such as hydrogen peroxide, potassium persulfate, sodium persulfate, and ammonium persulfate, and the like are exemplified. In some embodiments, the resin only comprises one thermal initiator, whereas in other embodiments the resin comprises two or more thermal initiators.

In some embodiments, either photo initiators or thermal initiators are used, whereas in other embodiments photo initiators and thermal initiators are combined.

In the additive manufacturing of the mold or mold insert, the mold material is sequentially cured, one layer at the time, to add one layer on top of another each other. In some embodiments the thickness of a cured layer of the mold is in the range of 1 to 2.000 μm when irradiated with an energy form such as light. In a particular set of embodiments, light is used that has a wavelength preferably corresponding to UVA or visible light. Alternatively, thermal energy from 60° C. to 400° C. or above, or 2 Photon energy or similar may be used.

It has been found that the average molecular weight between cross-linking points in the mold material is important for achieving both satisfactory solubility of the mold material as well as satisfactory thermal resistance, glass transition temperature and mechanical strength (also referred to in this document as “injection resistance”).

The average molecular weight between cross-linking points is calculated as follows, with a UV photocurable formulation used as an example:

Mi is short for Molecular Weight Between Cross-linking Points.

In the case of a monomer having two radical polymerizable reaction points, such as di(meth)acrylate, the molecular weight of the monomer is set as Mi as it is. In the case of a monomer having three or more radical polymerizable reaction points, such as tetra(meth)acrylate, the molecular weight of the monomer divided by the number of radical polymerizable reaction points is set as Mi.

The total content (parts by weight) of all components in the mold material (including not only radical polymerizable compounds but also photoinitiators, additives, etc.) Mi is set as A (=⊖Ci: Ci=content of i component).

Then, the sum of each Ci÷Mi is defined as the total number B (=Σ(Ci÷Mi)) of cross-links. In the case of a monomer or non-curable resin having one or less radical polymerizable reaction points, such as mono (meth)acrylate, zero is set as Ci÷Mi.

Finally, the average molecular weight between cross-linking points is calculated as A÷B.

The average molecular weight between cross-linking points (A÷B) of the mold material is preferably in the range of 500 to 10.000 Mc, g/mol. The lower limit of the range is preferably 800 Mc, g/mol, more preferred 1.000 Mc, g/mol. The upper limit is preferably 5.000 Mc, g/mol, more preferred 2.000 Mc, g/mol.

In some embodiments where the average molecular weight between cross-linking points is high, the solubility of the sacrificial mold in alkaline solvent is enhanced.

In embodiments where the average molecular weight between cross-linking points is small, the injection resistance of the sacrificial mold is enhanced.

It is known that the level of cross-linking of additively manufactured articles, and in this case molds can be affected by the level of curing achieved during—and after—the additive manufacturing process. As stated elsewhere, the lower the cross-linking density, the lesser the swelling can be. Accordingly, in some embodiments the level of cross-linking may be either increased or reduced during the additive manufacturing process to reach a desired balance between a swelling and a dissolution level. In some embodiments, a lower cross-linking density is desired, as the objective is to manufacture molds or mold elements that exhibit a fast dissolution. In other embodiments, a higher cross-linking density is desired, as the objective is to manufacture molds or mold elements that exhibit a high tensile strength and glass transition temperature.

For a particular set of embodiments it is important that the E-type viscosity of the resin is in the range of 1 to 10.000 mPa*s at 25 degrees C. or else the resin is not suitable for vat polymerization-based 3D printers based on UV-DLP, UV-LCD, or UV-laser based energy projection systems. In general, thin layers of 1-200 μm with a low viscosity are preferred. For other additive manufacturing system types, like material jetting, binder jetting, or plotters, other preferred viscosities may apply.

It is another object of the present invention to provide an UV curable resin, which is suitable for use in additive manufacturing of a sacrificial dissolvable mold as thoroughly described above.

It is yet another object of the present invention to provide a method for producing a molded article with a controlled moisture absorption. The method comprises the steps of:
a. additively manufacturing a sacrificial mold or mold insert made of a dissolvable material as disclosed above,
b. post-processing the mold, which post-processing may include one or more of the steps of cleaning, drying, curing and coating,
c. optionally storing the mold obtained in step b for a period of time,
d. filling the mold or mold insert obtained in step b with injection material using a casting or an injection molding process,
e. processing the injection material of step d in order to produce a molded article inside the mold by e.g. letting the injection material set or cure,
f. dissolving the mold in order to release the molded article obtained in step e, and
g. optionally rinsing the molded article.

In step a, a sacrificial additively manufactured mold or mold insert is produced by additively processing a dissolvable resin. Examples of dissolvable resins that are suitable for such applications are thoroughly described above. As mentioned above, these resins exhibit controlled absorption properties during storage prior to printing as well as during and after the additive manufacturing process, thereby supporting an improved additive manufacturing process, where a mold with high degree of dimensional accuracy is obtained. Examples of means to further control e.g. a cross-linking density to promote e.g. a specific dissolution rate and/or a specific tensile strength are also disclosed above.

The resin may be prepared by any method known in the art. Typically, the resin is prepared by thoroughly mixing the (meth)acrylamide-based monomer and the ethylene oxide-based oligomer having energy-reactive end groups, and then adding the cross-linking agent and optional further additives while thoroughly mixing.

In principle any kind of known printing process can be used, such as for example photopolymerization (e.g. UV-Digital Light Processing (DLP), UV, laser, LCD or Stereolithography (SL)), continuous liquid interface production (CLIP), Fused deposition Modelling (FDM), Selective Laser Melting (SLM), Material jetting, binder jetting, optical fabrication, photo-solidification, solid free-form fabrication, solid imaging and other 3D printing systems, a (selective) laser sintering system, a protrusion system, an extrusion-based 3D printer system, a 3D bio-printing or bio-plotting system, a droplet/“ink” jet-based system, a powder bed fusion system or a directed energy deposition system. Energy-curing systems, such as vat photopolymerization systems, have been known to produce parts with acceptable accuracies and surface qualities, and these systems are preferred for some of the embodiments mentioned herein. For other embodiments, additive manufacturing systems using energy-curing materials and having higher through-puts, such as binder jetting systems or volumetric printing systems, are preferred.

To manufacture objects by means of additive manufacturing, some embodiments employ a first curing/solidification that takes place during build-up in the additive manufacturing unit and that serves the purpose of setting the desired shape of the individual layers of the additively manufactured molds or parts of the mold or single use inserts/cores. Ideally, this first curing/solidification is only partial because complete curing of each individual layer may lead to internal stresses, warpage, loss of strength and other undesired artifacts.

To achieve the highest possible precision and minimal geometrical distortion, it is desirable to clean and possibly also dry the additively manufactured molds after printing.

To further increase the strength of the additively manufactured object and ensure a full and thorough curing, some embodiments employ a second (post) curing of the additively manufactured molds, as further described below.

Cleaning and post-curing may advantageously be performed by post-processing systems that are separate from the additive manufacturing apparatus, to ensure highest possible utilization of the additive manufacturing apparatus and to prevent bottlenecks. A suitable post-processing system is the one disclosed in international patent application PCT/EP2017/055841 on page 44, line 14-page 46, line 2 and shown in FIG. 12, item 600, which is incorporated herein by reference.

Accordingly, in step b, the sacrificial additively manufactured mold is post-processed so that a Ready-To-Fill (RTF) mold or mold insert is obtained.

The post-processing comprises at least one of the following steps: cleaning the mold, drying the mold, surface-treating the mold and post-curing the mold, as further described below.

The mold or mold insert is preferably cleaned in order to remove uncured resin in the interior of the mold. Cleaning the mold is of particular importance where UV-DLP UV-LCD or UV-SL is used, and may include in particular a rinsing procedure in which the mold is immersed in a bath of isopropanol, TPM (Tripropylene Glycol Methyl Ether) or a similar solvent to remove uncured material. If cleaning is not carried out, uncured material may interfere with the filling process, e.g. by pooling in bottom portions of the mold or clogging inlets or outlets. Such interference may result in loss of geometrical accuracy, incompletely molded objects, contamination of injection molding equipment and/or other undesired artifacts. Optionally the rinsing procedure is performed at elevated temperature (e.g., 50° C.), ultrasonication, agitation, stirring, vacuum aspiration or any combinations thereof. Alternatively, uncured resin may be fully or partially left on the surface of the mold or mold insert to promote a specific desired effect (e.g. increased smoothness). For embodiments employing this principle, pressurized air, centrifuging or a similar method may be used for partial removal.

Since the mold materials disclosed in the present invention exhibit improved absorption properties, they may absorb less cleaning solvent during the cleaning step. Accordingly, such additively manufactured molds are less likely to swell during cleaning, resulting in improved dimensional accuracy after the cleaning process.

Suitable examples of cleaning agents that can be used to clean the mold include alkaline and acidic water, pure H2O and alcohol-based solvents, such as methanol, ethanol, isopropyl alcohol, n-butanol, isobutanol, octanol, n-propyl alcohol, and acetylacetone alcohol; glycol-based solvents, such as ethylene glycol, ethylene glycol monomethyl ether, ethylene glycol monomethyl ether, ethylene glycol mono n-propyl ether, ethylene glycol mono n-butyl ether, diethylene glycol monomethyl ether, diethylene glycol monoethyl ether, propylene glycol monomethyl ether, propylene glycol monoethyl ether, propylene glycol monobutyl ether, tripropylene glycol monomethyl ether, ethylene glycol monomethyl ether acetate, propylene glycol monomethyl ether acetate, propylene glycol monomethyl ether acetate, methyl cellosolve, butyl cellosolve, and diethylene glycol ethyl ether; ketone-based solvents, such as acetone, methyl ethyl ketone, methyl isobutyl ketone, diisobutyl ketone, cyclohexanone, diacetone alcohol, and isophorone; hydrocarbon-based solvents, such as toluene, xylene, tetramethylbenzene, petroleum ether, petroleum naphtha, hydrogenated petroleum naphtha, solvent naphtha, cyclohexane, methylcyclohexane, octane, and decane; and ester-based solvents, such as ethyl acetate, propyl acetate, butyl acetate, isobutyl acetate, and amyl acetate. These may be used singly or in combination of two or more kinds thereof. Preferred cleaning agents include alcohol-based solvents and water, because of the detergency of the uncured resin. Furthermore, combinations of cleaning agents with water may also include surfactant, or a mixture of surfactants.

Drying the mold after cleaning includes any well-known drying method and may in particular include using pressurized air and/or a vacuum drying process and/or an oven drying process and/or a chemical drying process.

Surface-treating the mold during or after cleaning includes any surface-treating method known in the art, and may in particular include immersing the mold or the mold inserts in a bath comprising a surface-treating agent. In some embodiments, the surface-treating agent is a solute of the mold material, which may e.g., provide a smoothening of a surface. In other embodiments, the surface-treating agent is a solvent promoting dissolution of the mold. In yet other embodiments the surface-treating agent is a structural surface agent, such as for example an agent comprising microbeads or other materials that may be made to infiltrate the surface of the molded object.

In some embodiments, it is preferred to use a solvent based acrylic coating, such as a “systems 20 U-POL 20-85” clear coat used “as is” or diluted down to 5% with Xylen or another suitable paint thinner as a barrier between the mold and the injected material to avoid that the two elements can react with each other. Such coating can also prevent the exchange of chemical components that may inhibit the curing of the injected material. Moreover, such coating can also prevent colors from the mold material from being absorbed by the injected material.

In other embodiments, the coating will act as a barrier against water absorption from the surrounding atmosphere. In the case of using a coating that is dissolvable in an alkaline solvent that is used for the dissolving of the sacrificial mold, the “systems 20 U-POL 20-85” may be dissolved away from the molded article as a loose skin. In cases where a thick layer (10 μm) is added to the mold the dissolution of the mold is slowed down as the rate of penetration of the alkaline solvent may be slower. In these cases, the coating on the outer surface may simply be wiped off with a suitable thinner or diluent, or mechanically sanded off. The disadvantage of a coating is that it adds an extra layer to the cavity of the mold that may be inaccurately dispersed over the surfaces, causing a lower precision of the molding tool and there after the molded part. It is therefore a preferred solution to adapt the resin formulations absorption properties to counteract absorption.

As disclosed above, some of the technical problems solved by the present invention are associated with the absorption properties of the mold material. In some particular embodiments, it may be necessary to completely avoid absorption of moisture and/or liquid. In such embodiments, hydrophobic fillers may be employed to reduce or prevent absorption. Alternatively, the mold surface may be coated with a coating material, which completely inhibits any absorption of moisture and/or liquid.

As disclosed above, post-curing of the molds or mold inserts is of particular importance where DLP or SL is used for the manufacturing of sacrificial molds, especially where mold wall thicknesses need to be increased to accommodate higher temperatures and/or pressures. Complete and controlled curing is also of particular importance e.g., for biomedical applications, where no variations in the composition of process elements and tools are permitted. Depending on the formulation of the material used for the additive manufacturing of molds or mold elements, an in particular on the initiator(s) used, such post-curing of the molds or mold inserts may include any well-known post-curing method and in particular placing the mold in a reflective chamber and subjecting the mold to UV radiation and/or placing the mold in an oven and subjecting the mold to joule heating, microwave heating or another means of thermal energy and/or placing the mold in an environment (for example water) that is conductive for a specific type of chemical and/or thermal curing causing the mold or mold insert to cure or promote autopolymerisation. To increase speed, ease of operation, while at the same time obtaining the desired post-curing effects, one or more post-curing principles may advantageously be combined in a single post-curing apparatus.

Alternatively or additionally, the inclusion of certain components or additives in the sacrificial mold material may help promote complete post-curing. The formulations disclosed above are characterized by being suitable for a hybrid curing regime where a first (photo)curing takes place during the printing, and allows the additive manufacturing of a mold with a desired geometry. A second curing takes place during the post-curing, and is intended to fully solidify the sacrificial mold for provision of highest possible strength. This second curing is preferably a thermal curing, because it does not only cure visible surfaces as UV curing does, but also the internal cavity of the mold and the core of the mold. Moreover, thermal curing increases the evaporation of solvents and unreacted parts of the resin, and reduces or eliminates any undesired and/or uncontrolled reaction between the injection molded material and untreated resin, cleaning solvent and absorbed moisture. Moreover, thermal curing further increases the strength of the mold and resistance to absorb moisture that will result in swelling and decomposition of the mold material.

In step c, the mold or mold insert is stored. Absorption, and associated swelling and dissolution, may happen during storage. However, when using the resin according to the invention the absorption is controlled. As mentioned above, the absorption may be controlled by adding resin solvent to the resin, and/or increasing the cross-linking density in the additive manufacturing process and/or including moisture absorbers.

In step d, the sacrificial additively manufactured mold or mold insert is filled with injection material. Preferably, the mold is filled with injection material using injection molding. Alternatively, the mold or mold insert is filled using a casting process.

The injection material includes, but is not limited to, a thermoplastic polymer, a thermoplastic elastomer, a thermoplastic composite, thermoplastic rubber, a thermoplastic feedstock comprising metal powders, a thermoplastic feedstock comprising ceramic powders and thermoplastic feedstocks comprising other suitable powders. Alternative embodiments employ injection materials that are thermoset.

The filling of the mold can be done by any known injection molding method, such as for example thermoplastic injection molding, thermoplastic rubber injection molding, thermoplastic micro injection molding, thermoplastic powder injection molding (including thermoplastic metal injection molding and thermoplastic ceramic injection molding), thermoplastic blow molding, thermoplastic over molding, thermoplastic compression molding, thermoplastic insert molding or thermoplastic multi-shot molding. Injection methods may also include those employed for casting.

In preferred embodiments, the filling of the mold with injection material is performed as shown in FIG. 9, 10 or 11 in International patent application PCT/EP2017/055841, which is incorporated herein by reference.

In the present invention, the filling of the mold may be done at plastic melt temperatures in the range of 70-450 degrees C. and injection pressures in the range of 0.2-400 MPa. Alternatively, filling may have to be done at lower temperatures and pressures, where formulations have not been optimized to deliver highest possible tensile strength and glass transition temperature. Some embodiments have been optimized for applications with high melt temperatures and injection pressures, and may require a longer time to dissolve and/or an increased swelling. In other embodiments, where a fast dissolution or a minimized swelling is desired, injection temperatures and pressures may have to be reduced.

To increase speed, ease of use and precision of the molded object, it is often desirable to use mold tools and handling fixtures for efficient filling. For instance, it may be desirable to clamp a sacrificial mold in a suitably configured cavity or recess in a mold tool during filling, especially where higher temperatures and pressures are used, and where such clamping will help mitigate the risk of deformations that may result from such higher temperatures and pressures.

In one embodiment, the sacrificial mold is clamped by and/or supported by a mold tool before and during filling the mold in step d. In this embodiment, the cavity in the mold tool has dimensions that conform to the outer dimensions of the sacrificial mold, which results in clamping or supporting of the sacrificial mold in the mold tool cavity. At this point, problems may arise if the mold material swell due to absorption of humidity environment, because the mold may then not fit to the designed frame as required in order to obtain a molded article with dimension accuracy. This problem has also been overcome by the mold material according to the present invention.

In some cases, it may be that the sacrificial mold is smaller than the cavity in the mold tool and in such cases, it is beneficial to use an insert that can adapt the size of the cavity in the mold tool so that the dimensions of the adapted mold tool conform with outer dimensions of the sacrificial mold so that the sacrificial mold is clamped and/or supported by the mold tool before and during filling of the mold. Hence, in one embodiment an insert is used to adapt the size of a mold tool to dimensions that conform the outer dimensions of the sacrificial mold whereby the sacrificial mold is clamped by and/or supported by said mold tool with adapted size before and during filling the mold in step d. At this point, problems may arise if the mold material swell due to absorption of moisture from the environment because the gab will be smaller, which will hinder the mold in being used in this way. The dissolvable mold material of the present invention decreases, or even prevents, such swelling.

In a preferred embodiment, the sacrificial mold is clamped by and/or supported by a mold tool comprising a vacuum channel in fluid communication with the mold cavity. By introducing such vacuum channel, the filling of the mold is assisted by drawing a vacuum into said cavity prior to or during filling of the mold in step c. Examples of preferred mold having vacuum channels are shown for example in FIGS. 6, 7 and 8 of PCT/EP2017/055841, which is incorporated herein by reference.

FIGS. 8a-8c, 9a-9h, 10a-10d, and 11a-11d and related description of PCT patent application with application number PCT/EP2017/055841 by the same applicant are hereby incorporated by reference.

In step e, the injection material is processed so that a molded article is produced. Such process step is well-known in the art and typically includes dwelling and cooling of the injection material inside of the mold. When sacrificial polymer molds are used, the lower thermal capacity of the sacrificial polymer molds, compared with aluminum or steel tools may cause prolonged dwell times and cooling times as compared with standard injection molding. However, sacrificial molds or mold inserts may be removed from the injection molding machine as soon as the injection material has set enough to allow separation without sink-marks, which will help increase total through-put and reduce injection mold cycle times.

In step f, the sacrificial additively manufactured mold is dissolved, whereby the molded article is released.

The dissolution of the mold can be performed for example by immersing the mold with the molded article in a dissolving solvent, such as water, an inorganic solvent or an organic solvent. Suitable examples of solvents include, but are not limited to, water, sodium hydroxide, potassium hydroxide, calcium hydroxide, hydrochloric acid, sulfuric acid, fluorosulfonic acid, limonene, acetone and ethanol.

In some embodiments, the solvent is an aqueous alkaline solution, such as sodium hydroxide, potassium hydroxide, or calcium hydroxide. The pH of the aqueous alkaline solution is higher than 7, preferably pH is higher than 10 or even more preferred the pH is higher than 13.

In some embodiments, the dissolution process also comprises heating the dissolving solvent to a temperature in the range of 40 to 95 degrees C., such as for example 70 degrees C. The higher temperature will speed up the rate of dissolution. In some embodiments, the dissolution is assisted by application of agitation and/or sonication and/or circulation, which may also speed up the rate of dissolution.

Excessive swelling of the sacrificial mold or mold insert during the dissolution process is known to damage even very strong molded parts. In application, even an expansion of the mold or mold insert of as little as 10% may cause stresses in the molded part, which may exceed its yield strength, with consequent strain hardening, and often even surpass molded part ultimate tensile strength causing necking, and even failures/cracks. It is therefore paramount to have as little swelling as possible during the dissolution process. To the best of inventor's experience, it is desired to have a swelling rate of less than 10%, preferably less than 5% and even more preferably less than 2% in order to avoid or minimize the strain on the molded part.

The controlled absorption properties of the dissolvable molds of the present invention decrease the risk of the molded article changing dimension during the dissolution process due to swelling of the sacrificial mold during the dissolution step.

The ability to control swelling, and to keep it below specific thresholds, is of particular importance when molded parts are made with injection materials that comprise a binder component (to enable the injectability) and a solid constituent (e.g., a ceramic and/or a metal and/or a non-thermoplastic polymer powder). Such injection materials are hereafter referred to as feedstock, and include those used in metal injection molding (MIM) and ceramic injection molding (CIM).

The ability to control swelling, and to keep it below specific thresholds, is also of importance when molded parts are made with build materials from the group of traditional injection molding materials hereafter referred to as thermoplastics such as acrylic, polyester, polypropylene, polystyrene, nylon and so on. Other materials that can be mentioned are castable epoxies and urethanes as well as other rigid castable materials.

The ability to control swelling, and to keep it below specific thresholds, is also of particular importance in the manufacturing of molded part with thin walls, or when reinforced materials (fibers or particles) are used, as they may be stiffer and less ductile than unreinforced materials.

Accordingly, there is a need for materials and methods that allow the control of swelling of sacrificial molds or mold inserts during a dissolving process. This control can be achieved by means of the principles, formulations and methods disclosed above.

In step g, the molded article is rinsed, e.g., using purified water, to ensure complete elimination of mold residues and solvent residues.

In a preferred embodiment, the printing and the filling of the mold takes place in two steps independently of each other and preferably in two different apparatuses to increase total process throughput.

### EXAMPLES

### Example 1. Determination of Absorption Properties

The absorption properties are measured as described below. 5 mm solid spheres (see FIG. 5) are additively manufactured with an additive manufacturing system such as the one shown in FIG. 5 or FIG. 6 in International patent application PCT/EP2017/055841, which is incorporated herein by reference. Resin formulations containing increasing amounts of resin solvent (0.8-30% in weight) are used for the additive manufacturing. Reference spheres, based on pristine resin without added resin solvent, may also be additively manufactured to allow quantitative comparison. The pristine spheres and the spheres containing resin solvent may then be compared for their moisture/added resin solvent absorption/releasing behavior when exposed to the same environment conditions (e.g., 30% RH and 10° C.) for 24 hours. The 24 h data point has been used as reference, as industrial manufacturing will typically involve completing the production process until filling the mold within the first 24 h.

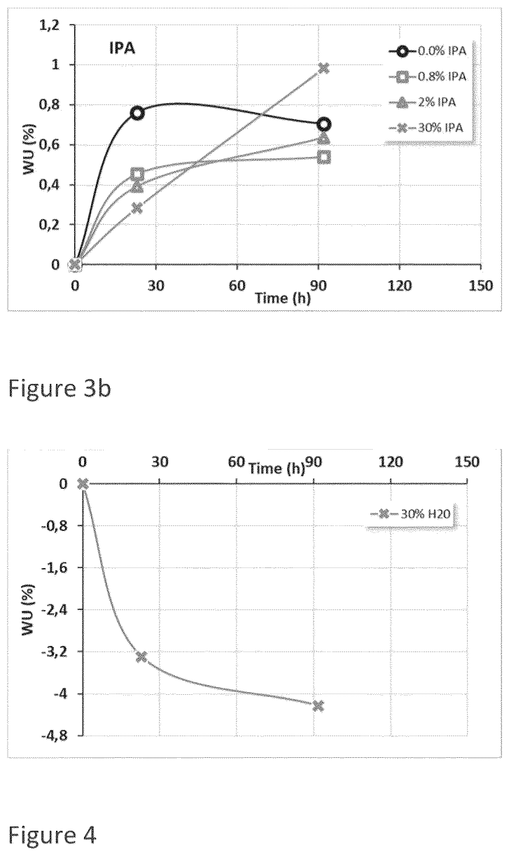

In an experimental test, the resin solvent is water. The amount of added water is typically 30% by weight based on total weight of resin. In this test, the water uptake from the environment, at a humidity of 30% at 10° C. and after 24 hours, was at a negative 3.2%, as indicated in FIG. 4.

In another experimental test, the solvent is water, and the amount of added water is 2% by weight. In this embodiment, the water uptake from the environment, at a humidity of 30% at 10° C. and after 24 hours, was at a positive 0.25% (FIG. 3b)

In another experimental test, the solvent is water, and the amount of added water is 0.8% by weight. In this test, the water uptake from the environment, at a humidity of 30% at 10° C. and after 24 hours, was at a positive 0.1% (FIG. 3b).

In another experimental test, the solvent is IPA. The amount of added IPA is 30% by weight. In this test, the water uptake from the environment, at a humidity of 30% at 10° C. and after 24 hours, was at a positive 0.3% (FIG. 3a).

In another experimental test, the solvent is IPA, and the amount of added IPA is 2% by weight. In this test, the water uptake from the environment, at a humidity of 30% at 10° C. and after 24 hours, was at a positive 0.38% (FIG. 3a).

In another experimental test, the solvent is IPA, and the amount of added IPA is 0.8% by weight. In this test, the water uptake from the environment, at a humidity of 30% at 10° C. and after 24 hours, was at a positive 0.45% (FIG. 3a).

At the lowest amount of added water in this case (0.8% and 2% by weight), the number of absorbed water molecules in the unit of time, results in a weight uptake for the mold or mold insert of 0.1-0.25% depending on the amount of added water. These values are lower than the ones observed in the same conditions (e.g., 30% RH, 10° C.) after 24 h for the mold or mold insert prepared from the pristine resin (water uptake 0.75% weight). On the other hand, when the amount of added water is high, in the case 30%, a large release of water molecules is observed, in this example it was 3.2%. This behavior might be associated with an amount of added water in the resin used to additively manufacture the mold or the mold insert that exceeds the amount that the mold or mold inserts may retain incorporated in that storing conditions (30% RH).

Therefore, the mold or the mold insert may release water molecules to the environment to reach the equilibrium with the same.

At the lowest amount of added IPA in this case (0.8% and 2% by weight), the number of absorbed water molecules in the unit of time, results in a weight uptake for the mold or mold insert of 0.40-0.45% depending on the amount of added IPA. These values are lower than the ones observed in the same conditions (e.g., 30% RH, 10° C.) after 24 h for the mold or mold insert additively manufactured from the pristine resin (0.75% weight). On the other hand, when the amount of added IPA is high, in the case 30%, a further reduction of water uptake is observed. In this example, it was 0.3%. The absorbed water molecules are likely replacing the bigger and heavier IPA molecules. The driving force in the IPA-to-water replacing process is the higher affinity of the hydrophilic functional groups contained in the mold or mold insert for water. This is likely associated with the higher polar character of water (dielectric constant 80.1) compared to IPA (dielectric constant 19.92).

### Example 2. Determination of Swelling Properties

Two resin formulations based on the use of two different types of oligomers, where one (formulation A) oligomer, namely polyethylene glycol-1000 (PEGDA 1000), has a high EO number (23) and the other oligomer (formulation B), namely polyethylene glycol-200 (PEGDA-200), has a low EO number (4), are compared by measuring the swelling via a swelling test.

In the swelling test, a sphere with a diameter of 5 mm is additively manufactured with each of the two resin formulations A and B, on an additive manufacturing system such as the one shown in FIG. 5 in International patent application PCT/EP2017/055841, which is incorporated herein by reference. After additive manufacturing, the resulting spheres A and B are cleaned using an alcohol such as IPA, and subsequently immerged into a vat containing a 1 Molar NaOH aqueous solution at 50 degrees Celsius (° C.). During regular intervals of 10-30 min. the spheres A and B are taken out of the vat and measured for their size, which allows the objective characterization of the rate of swelling (due to absorption), respectively shrinkage (due to dissolution) at that given time.

In a specific test, the formulations are characterized as:
formulation A consists of the following ingredients: 60% by weight of N-hydroxyethyl acrylamide (hereafter HEAA), 40% of polyethylene glycol-1000 (PEDGA-1000), and 1% TPO (Diphenyl(2,4,6-Trimethyl Benzoyl) Phosphine Oxide) UV photo initiator; and
formulation B consists of the following: 60% by weight of N-hydroxyethyl acrylamide (hereafter HEAA), 40% of polyethylene glycol-200 (PEDGA-200), and 1% TPO (Diphenyl(2,4,6-Trimethyl Benzoyl) Phosphine Oxide UV photo initiator.

The composition and the test results in form of maximum swelling and time for dissolution is seen in the Table below:

| | Formulation A | Formulation B |
|---|---|---|
| Monomer | HEAA | HEAA- |
| | 60% w | 60% w |
| Oligomer | PEDGA-1000 | PEDGA-200 |
| | (EO = 23) | (EO = 4) |
| | 40% w | 40% w |
| UV-initiator | TPO | TPO |
| | 1% w | 1% w |
| Maximum swelling | 8% | 66% |
| Time for the dissolution | 1.5 hours | 3 hours |
| in NaOH 1M @50° C. | | |

As a result of the different amounts of EO numbers for the oligomers, the formulation with a higher EO number (formulation A) only exhibits an 8% maximum swelling, while formulation B exhibits a 66% swelling rate. In addition to that, the dissolution time required to completely dissolve the sphere prepared from the formulation A (1.5 hours) is half the time required to completely dissolve a sphere prepared from the formulation B (3 hours). This difference can be explained as a consequence of the variation in EO numbers and the resulting impact on the dissolution behavior. More specifically, a high EO number corresponds with an additively manufactured sphere characterized by a dissolution process faster than the water absorption process. In formulation A, which incorporates this principle and has a higher EO modification number than formulation B, the better balance between absorption and dissolution results in the sphere being dissolved before an excessive amount of solvent is absorbed. Therefore, a limited swelling (8%, versus 66% for formulation B) is observed. By contrast, when the EO number is low—as in formulation B—the dissolution process is slower than the water absorption process. In this case, the sphere will experience substantially increased swelling before dissolution (66% vs. 8%, as observed with formulation A).

### Example 3. Preparation of Resins According to the Present Invention

This example describes the method developed for the preparation of the resins according to the present invention for (i) resins containing no other additives than an UV-absorber, and an UV-polymerization inhibitor, (ii) resins containing no other additives than a UV-absorber, an UV-polymerization inhibitor, and a polar resin solvent (e.g., either H2O or IPA).

The procedure to prepare resin containing no other additives than a UV-absorber, and an UV-polymerization inhibitor, comprises the following steps: a proper amount of a monomer (e.g., (meth)acrylamide-based at 60-80% in weight), an oligomer (e.g., acrylic ester at 10-20% in weight), and a crosslinker (e.g., mercaptan at 1-3% in weight) are mixed in an opaque dark HDPE bottle with the aid of a magnetic stirrer until homogeneous texture (visual inspection) is achieved. Then a photo-initiator (e.g., TPO at 0.1-5% in weight), a UV-blocker (e.g., Tinopal OB at 0.001-3% in weight), and a polymerization inhibitor (e.g., glycerol propoxylated at 0.001-3% in weight) are added at the required ratio/amount. The resulting resin is mixed with the aid of magnetic stirrer until a homogeneous texture and transparent resin (visual inspection) is achieved. Then, the viscosity of the resin thus obtained is measured. A reasonable range for the viscosity is 40-70 mPa s in a range of temperature between 20-25° C. The resin is then stored in an opaque dark HDPE bottle at room temperature (20-28° C.) for no longer than two years (shelf life).

The procedure to prepare resin containing no other additives than a UV-absorber, an UV-polymerization inhibitor, and a polar resin solvent (e.g., H2O or IPA) comprises the following steps: a proper amount of a monomer (e.g., (meth)acrylamide-based at 60-80% in weight), an oligomer (e.g., acrylic ester at 10-20% in weight), and a crosslinker (e.g., mercaptan at 1-3% in weight) are mixed in an opaque dark HDPE bottle with the aid of a magnetic stirrer until homogeneous texture (visual inspection) is achieved. Then a photo-initiator (e.g., TPO at 0.1-5% in weight), a UV-blocker (e.g., Tinopal OB at 0.001-3% in weight), a polymerization inhibitor (e.g., glycerol propoxylated at 0.001-3% in weight), and a polar solvent (e.g., H2O or IPA at 0.8-30% in weight) are added at the required ratio/amount. The resulting resin is mixed with the aid of magnetic stirrer until a homogeneous texture and transparent resin (visual inspection) is achieved. Then, the viscosity of the resin thus obtained is measured. A reasonable range for the viscosity is 40-70 mPa s in a range of temperature between 20-25° C. The resin is then stored in an opaque dark HDPE bottle at room temperature (20-28° C.) for no longer than two years (shelf life).

1. An additively manufactured mold or mold insert with controlled moisture and liquid absorption properties made of a dissolvable material for use in casting or injection molding processes, wherein the dissolvable material is an energy-cured resin comprising
a (meth)acrylamide-based monomer,
an ethylene oxide-based oligomer having energy-reactive end groups, and
a cross-linking agent,
wherein the resin is further characterized by
comprising a resin solvent in an amount of 0.1-50% by weight based on total weight of the resin, preferably 0.5-40% by weight, more preferably 0.8-30% weight based on the total weight of the resin,
or
comprising an ethylene oxide-based oligomer having energy-reactive end groups and an EO number in the range of 10 mol or more.

2. The additively manufactured mold or mold insert according to claim 1, wherein the mold or mold insert is a sacrificial mold or mold insert.

3. The additively manufactured mold or mold insert according to claim 1, wherein the (meth)acrylamide-based monomer is selected from the group consisting of (meth)acrylamide; N-1 substituted (meth)acrylamide compounds, such as N-isopropyl (meth)acrylamide, N-(1,1-dimethyl-3-oxobutyl)(meth)acrylamide, N-(hydroxymethyl)(meth)acrylamide, N-(butoxymethyl)(meth)acrylamide, and N-(2-hydroxyethyl)(meth)acrylamide; and N-2 substituted (meth)acrylamide compounds, such as (meth)acryloyl morpholine, (meth)acryloylpiperidine, N-(meth)acryloylpyrrolidine N-(meth)acryloyl-4-piperidone, N,N-dimethyl(meth)acrylamide, N,N-diisopropyl(meth) acrylamide, N,N-methylene-bis(meth)acrylamide, and N,N-dimethylaminopropyl (meth) acrylamide.

4. The additively manufactured mold or mold insert according to claim 1, wherein the ethylene oxide-based oligomer having energy-reactive end groups is selected from the group consisting of (poly)ethylene glycol di(meth)acrylate, EO-modified bisphenol-A di(meth)acrylate, tri(2-hydroxyethyl) isocyanurate tri(meth)acrylate and EO-modified trimethylol propane tri(meth)acrylate.

5. The additively manufactured mold or mold insert according to claim 1, wherein the cross-linking agent is a UV cross-linking agent selected from the group consisting of 2-Benzyl-2-dimethylamino-1-(4-morpholinophenyl)-butanone-1, (Dimethylhydroxyaceto-phenone, 1-Hydroxy-cyclohexylphenyl-ketone, “Dimethylhydroxyacetophenone, 2-Hydroxy-2-methyl-1-phenyl-1-propanone” Benzil dimethyl ketal 2,2-methoxy-1,2-diphenyl ethanone, Diphenylmethanone, multifunctional thioxanthone, 2,2-Diethoxyacetophenone, Methylbenzoylformate, 4-Methylbenzophenone, 2,4-Diethylthioxanthone, o-Methylbenzoylbenzoate, 1-(9,9-Dibutyl-9H-fluoren2-yl)-2-methyl-2-morpholin-4-yl-propan-1-one, 4-(4-methylphenylthio) benzophenone, 2-methyl-1-(4-methylthio) phenyl-2-morpholinopropan-1-one, Methyl benzoylformate, Phenylbis(2,4,6-trimethylbenzoyl) phosphine oxide, 4,4′-Bis (diethylamino) benzophenone, Isopropylthioxanthone, Diphenyl(2,4,6-trimethylbenzoyl)phosphine oxide, 4-Phenylbenz-ophenone, 1,7,7-Trimethylbicyclo, Benzophenone, Acetophenone, Anisoin, Anthraquinone, Anthraquinone-2-sulfonic acid, sodium salt monohydrate, Benzil, (Benzene) tricarbonylchromium, Benzoin ethyl ether, Benzoin, Benzoin isobutyl ether, Benzoin methyl ether, Benzophenone, 3, 3′, 4,4′-Benzophenonetetracarboxylic dianhydride, 4-Benzoylbiphenyl, Camphorquinone, 2-Chlorothioxanthen-9-one, (Cumene)cyclopentadienyliron(II) hexafluorophosphate, Dibenzosuberenone, 2,2-Diethoxyacetophenone, 4,4′-Dihydroxybenzophenone, 2,2-Dimethoxy-2-phenylacetophenone, 4-(Dimethylamino) benzophenone, 4,4′-Dimethylbenzil, 2,5-Dimethylbenzophenone, 3,4-Dimethylbenzophenone, 4′-Ethoxyacetophenone, Ethylanthraquinone, Ferrocene, 3′-Hydroxyacetophenone, 4′-Hydroxyacetophenone, 3-Hydroxybenzophenone, 4-Hydroxybenzophenone, 1-Hydroxycyclohexyl phenyl ketone, 2-Hydroxy-2-methylpropiophenone, 2-Methylbenzophenone, 3-Methylbenzophenone, Methybenzoylformate, Phenanthrenequinone, 4′-Phenoxyacetophenone, Thioxanthen-9-one.

6. The additively manufactured mold or mold insert according to claim 1, wherein the resin solvent is selected from the group consisting of alkaline solvents and acidic water, demineralized water, purified water, methanol, ethanol, isopropyl alcohol, n-butanol, isobutanol, octanol, n-propyl alcohol, and acetylacetone alcohol; glycol-based solvents, such as ethylene glycol, ethylene glycol monomethyl ether, ethylene glycol monomethyl ether, ethylene glycol mono n-propyl ether, ethylene glycol mono n-butyl ether, diethylene glycol monomethyl ether, diethylene glycol monoethyl ether, propylene glycol monomethyl ether, propylene glycol monoethyl ether, propylene glycol monobutyl ether, tripropylene glycol monomethyl ether, ethylene glycol monomethyl ether acetate, propylene glycol monomethyl ether acetate, propylene glycol monomethyl ether acetate, methyl cellosolve, butyl cellosolve, and diethylene glycol ethyl ether; ketone-based solvents, such as acetone, methyl ethyl ketone, methyl isobutyl ketone, diisobutyl ketone, cyclohexanone, diacetone alcohol, and isophorone; hydrocarbon-based solvents, such as toluene, xylene, tetramethylbenzene, petroleum ether, petroleum naphtha, hydrogenated petroleum naphtha, solvent naphtha, cyclohexane, methylcyclohexane, octane, and decane; and ester-based solvents, such as ethyl acetate, propyl acetate, butyl acetate, isobutyl acetate, and amyl acetate.

7. The additively manufactured mold or mold insert according to claim 1, wherein the EO number of the ethylene oxide-based oligomer having energy-reactive end groups is in the range of 10 mol or more, such as in the range of 10-300 mol, more preferred in the range of 14-200 mol.

8. The additively manufactured mold or mold insert according to claim 1, wherein the resin further comprises a filler, an UV absorber, a polymerization inhibitor, a dispersant or any mixture thereof.

9. The additively manufactured mold or mold insert according to claim 1, wherein the average molecular weight between cross-linking points of the mold material is in the range of 500 to 10.000 Me, g/mol.

10. An UV curable resin suitable for use in additive manufacturing of a dissolvable mold or mold insert according to claim 1.

11. The UV curable resin according to claim 10, wherein the E-type viscosity of the resin is in the range of 1 to 10.000 mPa*s at 25 degrees C.

12. A method for producing a molded article comprising the steps of:
a. additively manufacturing the sacrificial mold or mold insert made of a dissolvable material according to any one of the preceding claims,
b. post-processing the mold or mold insert obtained in step a,
c. optionally storing the mold or mold insert obtained in step b,
d. filling the mold or mold insert obtained in step b with injection material using a casting or an injection molding process,
e. processing the injection material of step c in order to produce a molded article inside the mold,
f. dissolving the mold or mold insert in order to release the molded article obtained in step d, and
g. optionally rinsing the molded article.

13. The method according to claim 12, wherein the post-processing of step b comprises at least one of the following steps: cleaning the mold or mold insert, drying the mold or mold insert, surface-treating the mold or mold insert and postcuring the mold or mold insert.

14. The method according to claim 12, wherein post-processing of step b comprises cleaning the mold in isopropanol, TPM (Tripropylene Glycol Methyl Ether) or water.

15. The method according to claim 12, wherein filling the mold or mold insert in step d is obtained by thermoplastic injection molding.

16. The method according to claim 12, wherein filling the mold or mold insert in step d is obtained by thermoset casting.

17. The method according to claim 12, wherein dissolving the mold is obtained by dissolving the mold or mold insert in an aqueous alkaline solution, preferably at pH in the range of higher than 10.

18. The method according to claim 12, wherein dissolving the mold or mold insert in step f is obtained by dissolving the mold in an aqueous alkaline solution at a temperature in the range of 40 to 95 degrees C.
